(19) United States
(12) Patent Application Publication
(10) Pub. No.: US 2022/0197261 A1
(43) Pub. Date: Jun. 23, 2022

(54) WORKPIECE QUALITY ANALYSIS METHOD AND WORKPIECE QUALITY ANALYSIS SYSTEM

(71) Applicant: Delta Electronics, Inc., Taoyuan City (TW)

(72) Inventors: Chin-Wei CHANG, Taoyuan City (TW); Wei-Ju CHEN, Taoyuan City (TW); Chun-Yung CHUANG, Taoyuan City (TW)

(21) Appl. No.: 17/378,187

(22) Filed: Jul. 16, 2021

(30) Foreign Application Priority Data
Dec. 18, 2020 (CN) 202011501582.3

(51) Int. Cl. G05B 19/418; G05B 13/02; G05B 23/02

(52) U.S. Cl. CPC G05B 19/41875; G05B 19/4183; G05B 23/0229; G05B 13/0265

(57) ABSTRACT

A workpiece quality analysis method includes: selecting an initial algorithm and a corresponding algorithm parameter combination from a plurality of preset algorithms; clustering a workpiece data into groups according to the initial algorithm and the algorithm parameter combination to obtain an initial model of the initial algorithm and a corresponding clustering result; obtaining a corresponding initial model evaluation index value according to the clustering result; selecting at least one parameter combination of another algorithm corresponding to the initial algorithm. According to the initial calculation, the method corresponds to the other algorithm parameter combination to group the workpiece data to obtain at least one other model and at least one other clustering result.

### CROSS REFERENCE TO RELATED APPLICATIONS

This Application claims priority of China Patent Application No. 202011501582.3, filed on Dec. 18, 2020, the entirety of which is incorporated by reference herein.

### BACKGROUND OF THE INVENTION

### Field of the Invention

The present disclosure is related to an analysis method and an analysis system, and in particular it is related to a workpiece quality analysis method and a workpiece quality analysis system.

### Description of the Related Art

The statistical process control chart method employed in current common quality control methods, such as Statistical Process Control (SPC), Process Capability Index (CP/CPK), etc., is a quality control method widely used by many multinational companies. By setting the control rules, the measurement values and statistics of the production process can be monitored in real time, and early warning can be given when the control rules are violated. However, the statistical process control chart method relies heavily on expert knowledge and experience to define the appropriate control rules. Control rules that are too loose will allow potential defect products to flow out, and control specifications that are too strict will cause unnecessary production waste. In addition, the process capability index describes the actual process capability of the process under control in a certain period of time. The rationality of the process capability index is also limited by the reliability of the control specification definition. The restriction is: when the specification definition is inappropriate or biased, this index cannot accurately reflect the process capability and problems.

These methods are highly dependent on manually defining control rules and specifications. Suitable control methods need to be revised iteratively by weighing quality and production costs. Therefore, even if there are systematic control tools and reports, they often rely on manual repeated judgments. In addition, high-dimensional abnormal phenomena are difficult to describe using traditional control charts and process capability indicators, so that potential defective products cannot be detected in time, resulting in more processing costs and negative effects such as customer returns.

Therefore, how to effectively detect high-dimensional abnormalities and variations that are difficult to describe by traditional quality control methods has become one of the problems that need to be solved in this field.

### BRIEF SUMMARY OF THE INVENTION

In accordance with one feature of the present invention, the present disclosure provides a workpiece quality analysis method. The workpiece quality analysis method includes following these steps: selecting an initial algorithm and an algorithm parameter combination corresponding to the initial algorithm from a plurality of preset algorithms; classifing the workpiece data into clusters according to the initial algorithm and the algorithm parameter combination to obtain an initial model of the initial algorithm and a clustering result corresponding to the initial algorithm; obtaining an initial model evaluation index value corresponding to the clustering result according to the clustering result; selecting at least one other algorithm parameter combination corresponding to the initial algorithm; classifing the workpiece data according to the other algorithm parameter combination corresponding to the initial algorithm to obtain at least one other model and at least one other clustering result; obtaining at least one other model evaluation index value corresponding to the other clustering result according to the other clustering result; selecting one of the best models corresponding to the initial algorithm according to the initial model evaluation index value and the other model evaluation index value; and determining whether there is any abnormal data in the workpiece data according to the best model.

In accordance with one feature of the present invention, the present disclosure provides a workpiece quality analysis system. The workpiece quality analysis system includes a storage device and a processor. The storage device is configured to store workpiece data. The processor is configured to read the workpiece data and perform the following operations: selecting an initial algorithm and an algorithm parameter combination corresponding to the initial algorithm from a plurality of preset algorithms; classify workpiece data into clusters according to the initial algorithm and the algorithm parameter combination to obtain an initial model of the initial algorithm and a clustering result corresponding to the initial algorithm; obtaining an initial model evaluation index value corresponding to the clustering result according to the clustering result; selecting at least one other algorithm parameter combination corresponding to the initial algorithm; clustering the workpiece data according to the other algorithm parameter combination corresponding to the initial algorithm to obtain at least one other model and at least one other clustering result; obtaining at least one other model evaluation index value corresponding to the other clustering result according to the other clustering result; selecting one of the best models corresponding to the initial algorithm according to the initial model evaluation index value and the other model evaluation index value; and determining whether there is any abnormal data in the workpiece data according to the best model.

The workpiece quality analysis method and workpiece quality analysis system shown in the present invention can automatically select the most suitable algorithm and corresponding parameters from a variety of built-in algorithms by designing model evaluation index values to generate a model and apply the analysis model. In other words, the present invention first uses the initial model to evaluate the index value in a single algorithm, selects a better parameter combination, and then selects the most suitable algorithm from multiple algorithms, and uses the most suitable algorithm and its parameter combination. It can achieve the effect of detecting production variation that is difficult to describe by traditional quality tools that do not obey the multivariate unimodal distribution.

### BRIEF DESCRIPTION OF THE DRAWINGS

The invention can be more fully understood by reading the subsequent detailed description and examples with references made to the accompanying drawings, wherein:

FIG. 1 is a block diagram of a workpiece quality analysis system in accordance with one embodiment of the present disclosure.

FIG. 2 is a flowchart of a workpiece quality analysis method in accordance with one embodiment of the present disclosure.

FIG. 3 is a schematic diagram showing the workpiece data in accordance with one embodiment of the present disclosure.

FIGS. 4A-4C are flowcharts of a workpiece quality analysis method 400 in accordance with one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “comprises” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

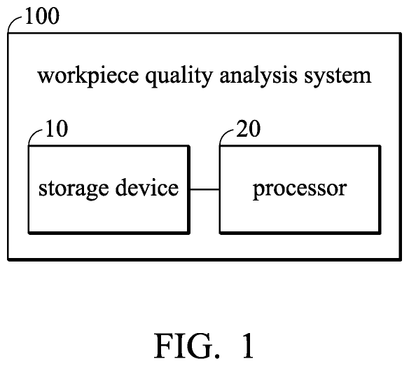

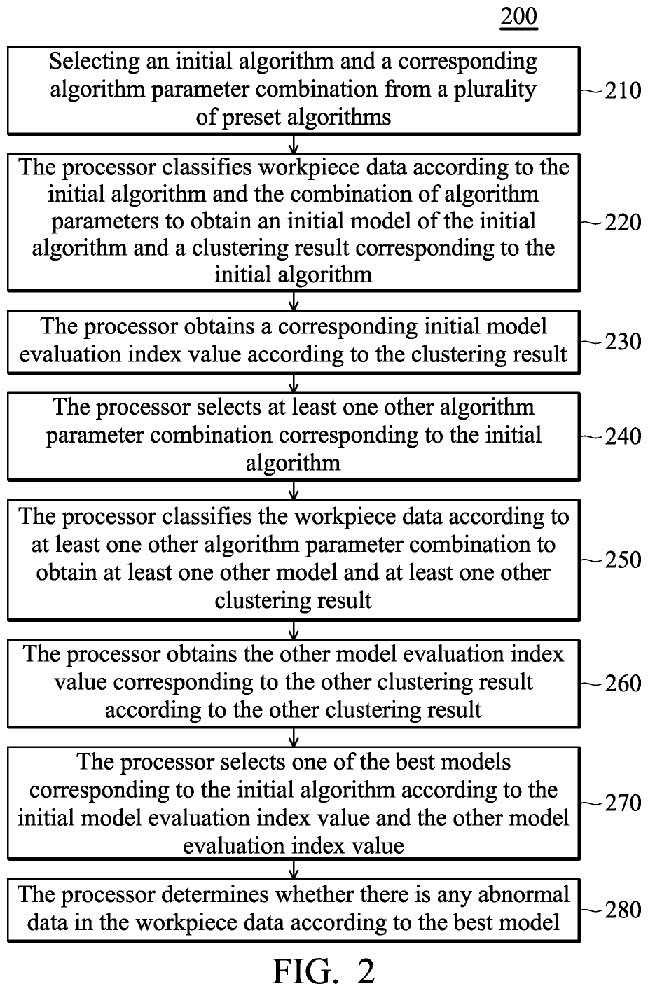

Please refer to FIGS. 1 and 2 together. FIG. 1 is a block diagram of a workpiece quality analysis system 100 in accordance with one embodiment of the present disclosure. FIG. 2 is a flowchart of a workpiece quality analysis method 200 in accordance with one embodiment of the present disclosure.

Please refer to FIG. 1. In FIG. 1, the workpiece quality analysis system 100 includes a storage device 10 and a processor 20. In one embodiment, the storage device 10 can be implemented as a read-only memory, a flash memory, a floppy disk, a hard disk, a compact disk, a flash drive, a tape, a network accessible database, or as a storage medium that can be easily considered by those skilled in the art to have the same function. In one embodiment, the processer 20 can be any electronic device having a calculation function. The processer 20 can be implemented using an integrated circuit, such as a microcontroller, a microprocessor, a digital signal processor, an application specific integrated circuit (ASIC), or a logic circuit.

In one embodiment, the workpiece quality analysis system 100 can be connected to various sensors or measuring devices in a wired or wireless manner. For example, the workpiece quality analysis system 100 is connected to a voltage measuring device to obtain voltage data of the workpiece. For example, the workpiece quality analysis system 100 is connected to a g-sensor to obtain acceleration data of the workpiece. For example, the workpiece quality analysis system 100 is connected to a gyro meter to obtain heading data of the workpiece.

In one embodiment, the workpiece is, for example, a motor, a fan, a panel, a mobile phone, and/or a semiconductor device.

In one embodiment, the storage device 10 is used to store workpiece data.

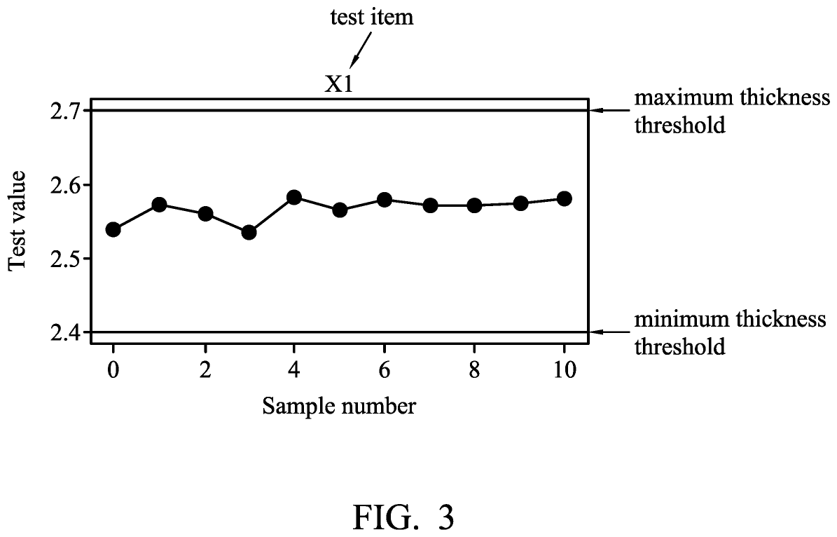

In one embodiment, the workpiece data includes a plurality of measurement item data corresponding to each of the plurality of workpieces. Please refer to FIG. 3, FIG. 3 is a schematic diagram showing the workpiece data in accordance with one embodiment of the present disclosure. In FIG. 3, the horizontal axis is the sample number. For the convenience of explanation, in this example, there are 10 samples (for example, panels). In some embodiments, the number of samples is not limited to this (for example, it can be 1000 samples). In addition, the vertical axis is the test value, and the unit is for example centimeter (cm). The measurement item name of this workpiece data is X1. For example, FIG. 3 can show that the thickness of 10 panels are tested by a testing instrument (the name of the test item X1 in FIG. 3 refers to the thickness of the panel).

In some embodiments, the maximum thickness threshold and the minimum thickness threshold may be preset as reference specifications.

In one embodiment, the workpiece data refers to the measurement item data of the product. Various test instruments or test methods are used to test the functionality and electrical properties of the product for obtaining the measurement item data, the measurement items of the same product must be the same, and the target values of the measurement items must also be consistent. These measurement item data are digitized format and can be converted into structured quantitative data.

In one embodiment, the workpiece data is, for example, motor speed, fan speed, panel length, panel width, panel thickness, cell phone length, cell phone width, cell phone thickness, or semiconductor related test data, etc. In one embodiment, the measurement item data of the motor controller product includes voltage value measurement items (for example, represented by the measurement item name X1), resistance value measurement items (for example, represented by the measurement item name X2), and transistor electrical performance test items (for example, represented by the test item name X3) . . . etc. However, those with general knowledge in the field should understand, and the workpiece data is not limited to this. In some embodiments, as long as the test data can be measured or collected and can reflect the quality of the product, it can be regarded as the workpiece data category defined by this method.

In one embodiment, the workpiece quality analysis method is to iteratively search for the best combination of algorithm parameters in the algorithm candidate group. Finally, the best combination of each algorithm is compared, and the best model is selected. For the convenience of explanation, the following first selects the combination of the initial algorithm and the algorithm parameters for explanation. Those with ordinary knowledge in the field should understand that the initial algorithm and the combination of algorithm parameters are included in the algorithm candidate group.

The following describes the flow of the workpiece quality analysis method 200 through FIG. 2. In one embodiment, the workpiece quality analysis method 200 applies unsupervised learning. That is, the workpiece data obtained by the processor 20 does not contain any labeled data (ground truth), only the workpiece data itself. The processor 20 cannot directly know whether there is abnormal data from the workpiece data. The goal of the workpiece quality analysis method 200 is to automatically analyze whether there is abnormal data in the workpiece data without any ground truth.

In step 210, the processor 20 selects an initial algorithm and a corresponding algorithm parameter combination from a plurality of preset algorithms.

In one embodiment, the plurality of preset algorithms include a k—means algorithm, an expectation-maximization (EM clustering) algorithm, and a hierarchical clustering algorithm. These algorithms are known and will not be repeated here. However, those with ordinary knowledge in the field should understand that the preset algorithm is not limited to this. In some embodiments, any clustering algorithm can be applied.

In one embodiment, the initial algorithm parameter combination of the initial algorithm includes one or more parameters.

For example, after the processor 20 obtains the workpiece data, it selects the k—means algorithm and its corresponding algorithm parameter combination from a plurality of preset algorithms. Since the initial parameter k of the k—means algorithm is an integer (for example, the initial parameter k=1 means that the workpiece data is divided into 1 cluster, for another example, the initial parameter k=2 means dividing the workpiece data into 2 clusters, and so on). Therefore, the processor 20 chooses to substitute the initial parameter k in step 220.

In some examples, the initial parameters corresponding to the preset algorithm can be a combination, for example, multiple values (for example, the value x, the value y) need to be input. These values are regarded as a combination (for example, expressed as (x, y)). When the processor 20 selects such a preset algorithm, it substitutes the algorithm parameter combination (x, y) into step 220.

Therefore, the algorithm parameter combination (or possibly a parameter value) to be substituted into step 220 by the processor 20 will be adjusted according to the parameter type corresponding to the preset algorithm selected by the processor 20.

In step 220, the processor 20 classifies workpiece data according to the initial algorithm and the combination of algorithm parameters to obtain an initial model of the initial algorithm and a clustering result corresponding to the initial algorithm. In one embodiment, in the k—means algorithm (for example, the initial algorithm), the classification is performed by a combination of parameters or according to the combination of parameters. For example, the initial parameter k is set to 1, which means that the workpiece data is divided into 1 cluster, and the initial parameter k is set to 2, which means that the workpiece data is divided into 2 clusters. In this example, the processor 20 groups a piece of workpiece data according to the k—means algorithm and the combination of algorithm parameters (the initial parameter k is set to 1) to obtain an initial model of the k—means algorithm. In one embodiment, the corresponding clustering result refers to the result of the input data generated by the clustering algorithm. For example, there are 100 pieces of workpiece data, and the result generated by the clustering algorithm is divided into two clusters of 50 pieces and 50 pieces. In one embodiment, the initial model can be one of the algorithm architectures of the initial algorithm. In this way, the corresponding initial model evaluation index value can be obtained from the clustering result to determine the accuracy of the initial model.

For example, after the processor 20 substitutes 1000 pieces of workpiece data (for example: test item X1, test item X2, test item X3 . . . ) and initial parameter k (default is 1) into the k—means algorithm (that is, the initial algorithm), and gets an initial model of k—means algorithm. In one embodiment, the workpiece data may be multivariate data, and multivariate represents data of multiple measurement items, not multiple data.

In step 230, the processor 20 obtains a corresponding initial model evaluation index value according to the clustering result.

In one embodiment, the initial model evaluation criterion can be Bayesian Information Criterion (BIC). BIC uses subjective probabilities to estimate part of the unknown state when incomplete information is obtained, and then uses Bayesian formula to correct the probability of occurrence. Finally, the expected value and the modified probability are used to make the optimal decision, so that the accuracy of the model can be evaluated. BIC is a commonly used optimal model selection criterion (which can be regarded as a known function) in the field of machine learning.

In one embodiment, the processor 20 calculates the initial BIC score (i.e., the initial model evaluation index value) corresponding to the initial model.

In step 240, the processor 20 selects at least one other algorithm parameter combination corresponding to the initial algorithm.

For example, the processor 20 selects the initial parameter k of the k—means algorithm. At this time, k is set to 2, which means that the workpiece data is divided into 2 clusters.

In step 250, the processor 20 classifies the workpiece data according to at least one other algorithm parameter combination to obtain at least one other model and at least one other clustering result.

For example, after the processor 20 input 1000 pieces of workpiece data and the initial parameter k (set to 2 this time) into the k—means algorithm, another model of the k—means algorithm is obtained.

In step 260, the processor 20 obtains the other model evaluation index value corresponding to the other clustering result according to the other clustering result.

In one embodiment, the processor 20 calculates another BIC score (i.e., another model evaluation index value) corresponding to another model.

In step 270, the processor 20 selects one of the best models corresponding to the initial algorithm according to the initial model evaluation index value and the other model evaluation index value.

In one embodiment, the selection of the most suitable one in step 270 represents the selection of the maximum value of the model evaluation index. More specifically, the processor 20 selects the one with the highest score from the initial BIC score and another BIC score. Assuming that the another BIC score is the maximum of the two, the best algorithm parameter combination of the k—means algorithm is obtained as the result of 2. That is, when the parameter k=2 (when the workpiece data is divided into 2 clusters), k—means algorithm has the best model.

In step 270, the processor 20 selects at least one other algorithm from the preset algorithms, and applies at least one other algorithm to calculate at least one best other algorithm parameter combination.

In step 280, the processor 20 determines whether there is any abnormal data in the workpiece data according to the best model.

For example, the processor 20 selects the EM algorithm to calculate at least one best combination of other algorithm parameters.

In one embodiment, when the k—means algorithm is the initial algorithm, the processor 20 is further used to select at least one other algorithm (such as the EM expectation algorithm) and the corresponding algorithm parameter combination; according to the other algorithm, the algorithm parameter combination of the method (such as the EM algorithm) groups the workpiece data to obtain an initial model of at least one other algorithm (such as the EM algorithm) and a corresponding clustering result (such as dividing the workpiece into 3 groups)), calculate the corresponding clustering result to obtain the corresponding initial model evaluation index value (for example, 0.5); select at least one other parameter combination of at least one other algorithm. According to at least one other parameter combination of the other algorithm, the workpiece data is classified to obtain at least one other model of at least one other algorithm and at least one other clustering result (for example, the workpiece is divided into 4 clusters), and at least one other clustering result is calculated to obtain the corresponding at least one other model evaluation index value (for example, 0.7). The processor 20 selects the most suitable initial model evaluation index value (for example 0.5) and at least one other model evaluation index value (for example 0.7) (referring to the model evaluation index value: for example, the larger the BIC, the better; the higher the model evaluation index value, the more suitable it is), selects one of the best models of at least one other algorithm (such as the EM algorithm), selects the best model of the other algorithm (such as the EM algorithm) and selects the most suitable model (for example, it selects the most suitable model from the corresponding models of k—means algorithm and hierarchical clustering algorithm: for example, the model evaluation index value of the EM algorithm is the most suitable if the value is smaller). According to the most suitable one, the processor 20 determines whether there is abnormal data in the workpiece data.

For example, the processor 20 finally selects the best algorithm parameter combination of the EM algorithm as 3. That is, when the workpiece data is divided into 3 clusters, the EM algorithm has the best model. In one embodiment, the method for the processor 20 to select the best algorithm parameter combination is similar to steps 210 to 260. The difference lies in the use of different algorithms, and the combination of algorithm parameters selected for different algorithms and the next algorithm parameter combination can be adjusted.

In one embodiment, the processor 20 selects at least one other algorithm among these preset algorithms, cooperates with at least one other algorithm parameter combination to generate at least one candidate model, and selects the best model and at least one candidate model according to the most suitable one, determines whether there is any abnormal data in the workpiece data. Candidate model refers to the selection of a better model based on BIC after using multiple algorithms except for the initial algorithm. In one embodiment, the preset algorithm, for example, adopts k—means algorithm, EM algorithm, and hierarchical clustering algorithm. For example, when the processor 20 selects the EM algorithm among the preset algorithms, cooperates with the EM algorithm to generate at least one candidate model, and selects the best model (generated in step 270, for example, when the parameter k=2, the k—means algorithm has the best model) and at least one candidate model (for example, the model corresponding to each of the hierarchical clustering algorithm and the EM algorithm) is the most suitable, and based on the most suitable one, a determination is made as to whether there is any abnormal data in the workpiece data.

In one embodiment, the processor 20 selects the best algorithm parameter combination of the k—means algorithm (initial algorithm) to be 2, and the best other algorithm parameter combination of the maximum expected algorithm to be each corresponding to 3. The model with the highest BIC score. For example, when the optimal algorithm parameter combination of k—means algorithm (initial algorithm) is 2, the corresponding BIC score is the largest, based on this condition, the processor 20 considers the model generated when the algorithm parameter combination of the k—means algorithm is 2 as the optimal one.

In one embodiment, the processor 20 determines that whether there is abnormal data in the workpiece data according to the most suitable one in the models.

In one embodiment, multiple pieces of workpiece data normally fall within a certain range. For example, the thickness of the display may fall within the range of 2.5-2.6 cm. Therefore, the entire batch of workpiece data should conform to multivariate unimodal distributions under normal conditions. That is, there is only one obvious peak in the data distribution. In other words, under normal conditions, the entire batch of workpiece data should be classified into the same cluster by the model. Therefore, when the model determines that the entire batch of workpiece data has multiple clusters, the processor 20 determines that there are abnormal data in the workpiece data. In other words, the workpiece data will be divided into clusters, and the decision condition for determining abnormalities is divided into several clusters. When the workpiece data is divided into one cluster, it means no abnormality, and when the workpiece data is divided into multiple clusters, it indicates the presence of an existing abnormality.

It can be seen from the description above that the workpiece quality analysis method 200 applies unsupervised learning. That is, there is no marked data in the workpiece data obtained by the processor 20, and the above steps 210 to 280 can automatically analyze whether there is abnormal data in the workpiece data. In addition, the workpiece quality analysis method 200 can be applied to analyze workpiece data of different test items. Therefore, the workpiece quality analysis method 200 can support multivariate analysis, can describe the interactive relationship between multiple items, and analyze high-dimensional abnormalities and variations that cannot be detected by traditional quality control methods. In addition, since the workpiece quality analysis method 200 does not need to define abnormal boundaries or specifications in advance. Therefore, it is not interfered by artificially defined inappropriate control rules and specifications, and can automatically find the most suitable and optimal algorithm parameter combination and its corresponding algorithm to generate a model.

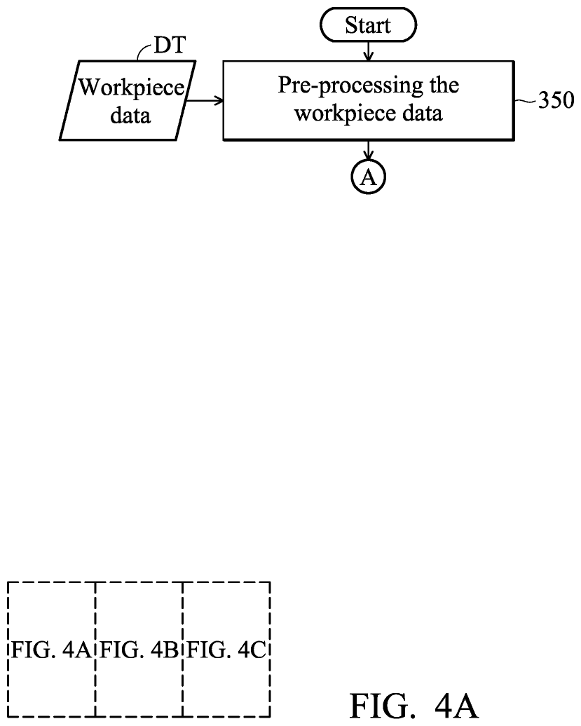

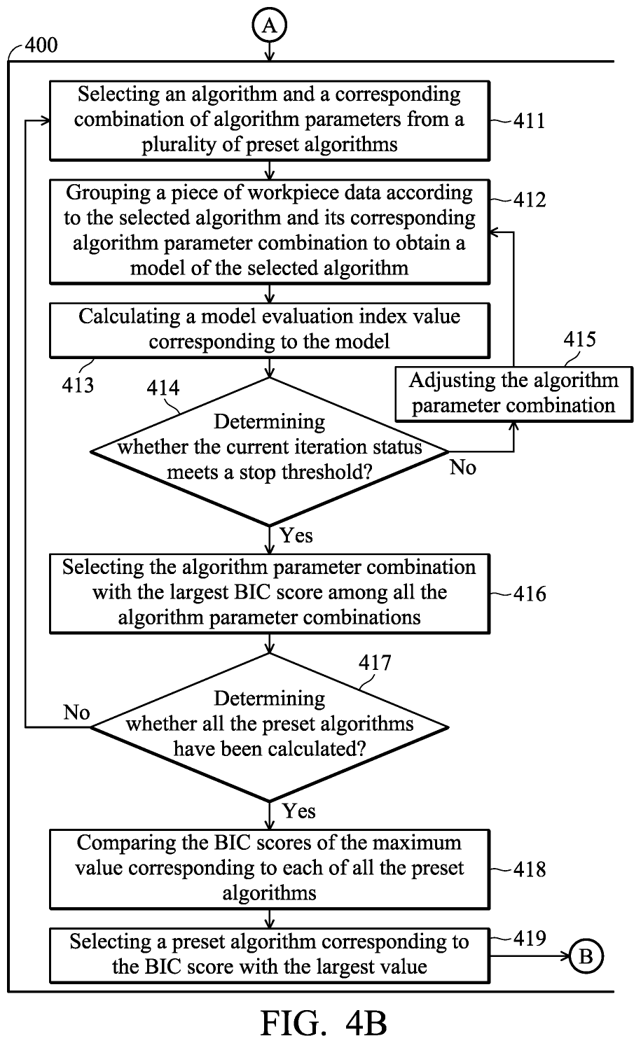

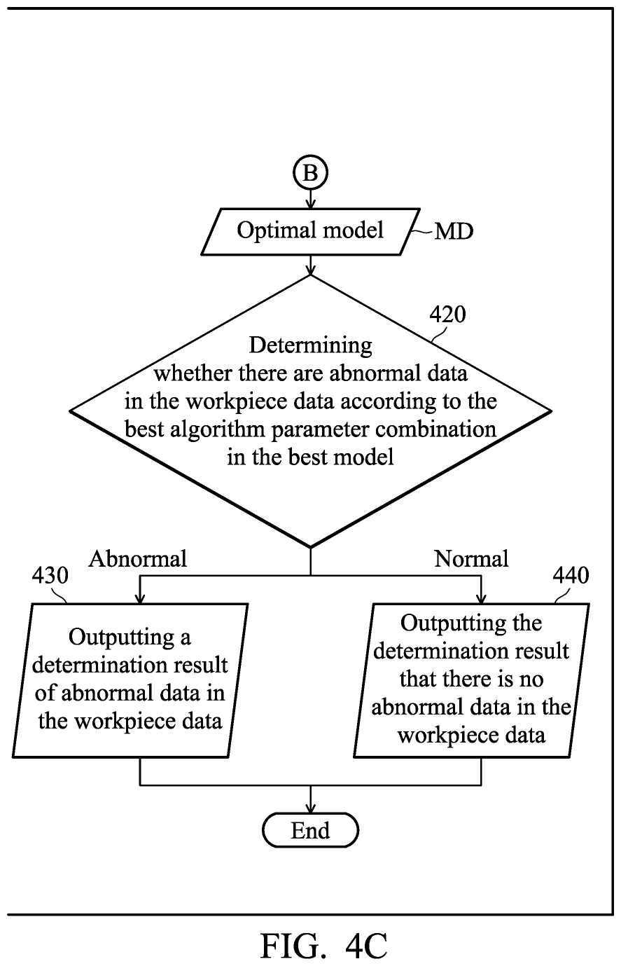

FIGS. 4A-4C are flowcharts of a workpiece quality analysis method 400 in accordance with one embodiment of the present disclosure. In one embodiment, after the processor 20 receives the workpiece data DT, it pre-processes the workpiece data DT through known methods such as normalization or data transposition (step 350), and then applies the pre-processed workpiece data DT carries out the method 400 of workpiece quality analysis. Steps 411 to 419 are used to select a model.

In step 411, the processor 20 selects an algorithm and a corresponding combination of algorithm parameters from a plurality of preset algorithms.

In one embodiment, the processor 20 selects the k—means algorithm and selects the parameter k=1 as the algorithm parameter combination.

In step 412, the processor 20 groups a piece of workpiece data DT according to the selected algorithm and its corresponding algorithm parameter combination to obtain a model of the selected algorithm.

In one embodiment, the processor 20 groups the workpiece data DT according to the k—means algorithm and the parameter k=1 to obtain a model of the k—means algorithm.

In step 413, the processor 20 calculates a model evaluation index value corresponding to the model.

In one embodiment, the processor 20 calculates the BIC score (i.e., the model evaluation index value) corresponding to the model.

In step 414, the processor 20 determines whether the current iteration status meets a stop threshold (including but not limited to the upper limit of the number of iterations). If the processor 20 determines that the stop threshold is not met, it proceeds to step 415, and if the processor 20 determines that the stop threshold is met, it proceeds to step 416.

In one embodiment, the preset upper limit of the k—means algorithm and its corresponding iteration number is 10, and the parameter k adjustment amount of each iteration is 1, and the processor 20 determines whether the algorithm parameter combination satisfies the condition of parameter k=10.

In one embodiment, the preset k—means algorithm will be iterated 10 times. That is, steps 412 to 414 can be regarded as a loop executed 10 times, and the parameters used in each execution are different. When steps 412 to 414 are executed for 1 to 9 times, the processor 20 determines that the number of iterations does not meet the stop threshold (the upper limit of the number of iterations), and then proceeds to step 415. When steps 412 to 414 are executed 10 times, the processor 20 judges that the stop threshold is met, and proceeds to step 416.

In step 415, the processor 20 adjusts the algorithm parameter combination.

In one embodiment, the processor 20 adds 1 to the parameter k to become the parameter k=2 (current parameter). Then return to step 412. At this time, the processor 20 classifies a piece of workpiece data according to the selected algorithm and the current parameters to obtain another model of the selected algorithm. When the loop formed in steps 412 to 414 is executed for the 10th time, the processor 20 in step 414 determines that the parameter k=10, which meets the stop threshold value, and proceeds to step 416.

In other words, the processor 20 generates the next current parameter to be substituted into step 412 in step 415.

In step 416, the processor 20 selects the algorithm parameter combination with the largest BIC score among all the algorithm parameter combinations.

In one embodiment, the processor 20 selects the parameter with the largest BIC score among the parameters k=1 to 10. For example, when the parameter is k=3, which corresponds to the BIC score with the maximum value. The processor 20 selects the parameter k=3, and the corresponding BIC score and other information are stored in the storage device 10 when the parameter k=3.

In step 417, the processor 20 determines whether all the preset algorithms have been calculated. If the processor 20 determines that all the preset algorithms have been calculated, it proceeds to step 418. If the processor 20 determines that not all the preset algorithms have been calculated, it proceeds to step 411.

In one embodiment, it is assumed that there are three preset algorithms to be compared. The execution order of the three algorithms is k—means algorithm, EM algorithm, and hierarchical clustering algorithm. At this time, after returning to step 411 (step 411 is executed for the second time), the processor 20 will select the EM algorithm to perform the above steps 412 to 416. When step 416 is entered again, the processor 20 selects the algorithm parameter combination with the maximum BIC score among the algorithm parameter combinations of the EM algorithm (for example, when the parameter is k=4, the BIC score with the maximum value), and the information related to the EM algorithm is recorded in the storage device 20. Then, step 417 is entered again. This time, in step 417, the processor 20 determines that not all the preset algorithms have been calculated. Therefore, it returns to step 411 again (step 411 is executed for the third time). The processor 20 selects a hierarchical clustering algorithm to perform the above steps 412 to 416. When step 416 is entered again, the processor 20 selects the algorithm parameter combination with the maximum BIC score among the algorithm parameter combinations of the hierarchical clustering algorithm (for example, when the parameter is k=5, the BIC score with the maximum value), and records information related to the hierarchical clustering algorithm in the storage device 20.

When the processor 20 determines in step 417 that all the preset algorithms are calculated, it means that the storage device 20 stores the BIC score corresponding to the k—means algorithm when the parameter k=3, and the BIC score corresponding to the EM algorithm when the parameter k=4 and the BIC score corresponding to the hierarchical clustering algorithm when the parameter k=5.

In step 418, the processor 20 compares the BIC scores of the maximum value corresponding to each of all the preset algorithms.

In step 419, the processor 20 selects a preset algorithm corresponding to the BIC score with the largest value.

In one embodiment, it is assumed that the BIC score corresponding to the k—means algorithm when the parameter k=3 is 8100, the BIC score corresponding to the EM algorithm when the parameter k=4 is 9500, and the BIC score corresponding to the hierarchical clustering algorithm when the parameter k=5 is 9000. Then the processor selects the model corresponding to the maximum initial BIC score of 9500. That is, the model established by the EM algorithm and the parameter k=4.

In one embodiment, assuming that the k—means algorithm has the same BIC score at parameter k=3, the EM algorithm at parameter k=4, and the hierarchical clustering algorithm at parameter k=5, the corresponding BIC scores are all the same, the processor 20 selects the algorithm according to the preset algorithm selection order, for example, the k—means algorithm is preferred.

In one embodiment, the processor 20 regards the modulation of the maximum expected algorithm at the parameter k=4 as a best model MD. In the case of a single algorithm, the best model is used here to determine whether there is abnormal data. In the case of two or more algorithms, this refers to the “most suitable”.

In step 420, the processor 20 determines whether there are abnormal data in the workpiece data according to the best algorithm parameter combination in the best model MD (for example, the parameter k=4). If the processor 20 performs analysis based on the best algorithm parameter combination in the best model MD (such as parameter k=4), when the parameter k>1 indicates that the workpiece data does not obey the multivariate unimodal distribution, it is judged that the workpiece data has abnormal data. Then go to step 430. If the processor 20 performs analysis based on the best algorithm parameter combination in the best model MD (such as parameter k=1), when the parameter k=1, it means that the workpiece data obeys the multivariate unimodal distribution, and it is judged that the workpiece data does not contain abnormal data. Then go to step 440.

In one embodiment, multiple pieces of workpiece data normally fall within a certain range. For example, the thickness of the display may fall within the range of 2.5 to 2.6 cm. Therefore, the entire batch of workpiece data should conform to a multivariate unimodal distribution under normal conditions. That is, there is only one obvious peak in the data distribution. In other words, under normal conditions, the entire batch of workpiece data should be judged as the same cluster by the model. Therefore, the best algorithm parameter combination (such as parameter=4) means that the workpiece data has multiple clusters, indicating that the distribution has multiple obvious peaks, which does not conform to the multivariate unimodal distribution, and the processor 20 determines that the workpiece data has abnormal data.

In another embodiment, it is assumed that the best algorithm parameter combination (such as parameter k=1) represents that there is only one obvious peak in the distribution of the workpiece data, and the values of the workpiece data are within a certain range, and there is no obvious clustering, then the processor 20 determines that there is no abnormal data in the workpiece data.

In step 430, the processor 20 outputs a determination result of abnormal data in the workpiece data.

In step 440, the processor 20 outputs the determination result that there is no abnormal data in the workpiece data.

The workpiece quality analysis method and workpiece quality analysis system shown in the present invention can automatically select the most suitable algorithm and corresponding parameters from a variety of built-in algorithms by designing model evaluation index values to generate a model and apply the analysis model. In other words, the present invention first uses the initial model to evaluate the index value in a single algorithm, selects a better parameter combination, and then selects the most suitable algorithm from multiple algorithms, and uses the most suitable algorithm and its parameter combination. It can achieve the effect of detecting production variation that is difficult to describe by traditional quality tools that do not obey the multivariate unimodal distribution.

The method of the present invention, or a specific type or part thereof, can exist in the form of code. The code can be included in physical media, such as floppy disks, CDs, hard disks, or any other machine-readable (such as computer-readable) storage media, or not limited to external forms of computer program products. Among them, When the program code is loaded and executed by a machine, such as a computer, the machine becomes a device for participating in the present invention. The code can also be transmitted through some transmission media, such as wire or cable, optical fiber, or any transmission type. When the code is received, loaded and executed by a machine, such as a computer, the machine becomes used to participate in this Invented device. When implemented in a general-purpose processing unit, the program code combined with the processing unit provides a unique device that operates similar to the application of a specific logic circuit.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

What is claimed is:

1. A workpiece quality analysis method, comprising:
storing workpiece data;
reading the workpiece data:
selecting an initial algorithm and an algorithm parameter combination corresponding to the initial algorithm from a plurality of preset algorithms;
classifying the workpiece data according to the initial algorithm and the algorithm parameter combination to obtain an initial model of the initial algorithm and a clustering result corresponding to the initial algorithm;
obtaining an initial model evaluation index value corresponding to the clustering result according to the clustering result;
selecting at least one other algorithm parameter combination corresponding to the initial algorithm;
classifying the workpiece data according to the other algorithm parameter combination corresponding to the initial algorithm to obtain at least one other model and at least one other clustering result;
obtaining at least one other model evaluation index value corresponding to the other clustering result according to the other clustering result;
selecting one of the best models corresponding to the initial algorithm according to the initial model evaluation index value and the other model evaluation index value; and
determining whether there is abnormal data in the workpiece data according to the best model.

2. The workpiece quality analysis method of claim 1, wherein a most suitable model is selected from the best model and at least one candidate model, and based on the most suitable model, a determination is made as to whether there is abnormal data in the workpiece data.

3. The workpiece quality analysis method of claim 2, wherein the other algorithm is selected from the preset algorithms, and the other algorithm is combined with at least one other algorithm parameter to generate the at least one candidate model.

4. The workpiece quality analysis method of claim 2, wherein the most suitable model is selected according to the larger model evaluation index value of the best model and of the at least one candidate model.

5. The workpiece quality analysis method of claim 2, wherein when the workpiece data is grouped, it is determined that the workpiece data has abnormal data.

6. A workpiece quality analysis system, comprising:
a storage device, configured to store workpiece data;
a processor, configured to read the workpiece data and perform the following operations:
selecting an initial algorithm and an algorithm parameter combination corresponding to the initial algorithm from a plurality of preset algorithms;
classifying the workpiece data according to the initial algorithm and the algorithm parameter combination to obtain an initial model of the initial algorithm and a clustering result corresponding to the initial algorithm;
obtaining an initial model evaluation index value corresponding to the clustering result according to the clustering result;
selecting at least one other algorithm parameter combination corresponding to the initial algorithm;
classifying the workpiece data according to the other algorithm parameter combination corresponding to the initial algorithm to obtain at least one other model and at least one other clustering result;
obtaining at least one other model evaluation index value corresponding to the other clustering result according to the other clustering result;
selecting one of the best models corresponding to the initial algorithm according to the initial model evaluation index value and the other model evaluation index value; and
determining whether there is abnormal data in the workpiece data according to the best model.

7. The workpiece quality analysis system of claim 1, wherein the processor is further configured to execute the following steps:
selecting a most suitable model from the best model and at least one candidate model, and determining whether there is abnormal data in the workpiece data based on the most suitable model.

8. The workpiece quality analysis system of claim 7, wherein the processor is further configured to execute the following steps:
selecting the other algorithm from the preset algorithms, and generating the at least one candidate model by the other algorithm combined with at least one other algorithm parameter.

9. The workpiece quality analysis system of claim 6, wherein the processor is further configured to execute the following steps:
selecting the most suitable model according to the larger model evaluation index value of the best model and of the at least one candidate model.

10. The workpiece quality analysis method of claim 7, wherein when the workpiece data is grouped, it is determined that the workpiece data has abnormal data.
